(19) United States
(12) Patent Application Publication
(10) Pub. No.: US 2013/0249788 A1
(43) Pub. Date: Sep. 26, 2013

(54) INFORMATION PROCESSING APPARATUS, COMPUTER PROGRAM PRODUCT, AND PROJECTION SYSTEM

(71) Applicants: Satoshi MITSUI, Kanagawa (JP); Kazuhiro TAKAZAWA, Tokyo (JP)

(72) Inventors: Satoshi MITSUI, Kanagawa (JP); Kazuhiro TAKAZAWA, Tokyo (JP)

(21) Appl. No.: 13/842,704

(22) Filed: Mar. 15, 2013

(30) Foreign Application Priority Data
Mar. 22, 2012 (JP) 2012-065525

(51) Int. Cl. G06F 3/16; G06F 3/01

(52) U.S. Cl. CPC G06F 3/167; G06F 3/017
USPC 345/156

(57) ABSTRACT

An information processing apparatus includes: a role storage unit that stores therein motion information concerning a motion of a user and a role of the user in a manner associated with each other; a detecting unit that detects a motion of a user; a determining unit that determines a role corresponding to motion information concerning a motion of a user detected by the detecting unit, based on the role storage unit; and an operation authorization unit that gives a user operating authority for an execution target device to be instructed to perform an operation by a predetermined motion of the user, the operating authority corresponding to a role of the user determined by the determining unit.

### CROSS-REFERENCE TO RELATED APPLICATIONS

The present application claims priority to and incorporates by reference the entire contents of Japanese Patent Application No. 2012-065525 filed in Japan on Mar. 22, 2012.

### BACKGROUND OF THE INVENTION

1. Field of the Invention

The present invention relates to an information processing apparatus, a computer program product, and a projection system.

2. Description of the Related Art

There have been some technologies available that allow a projection device such as a projector, which projects an image on a screen, to be operated from a remote place without touching the projection device. For example, a known technology operates a projection device through directions for various operations provided from an operating medium such as a remote controller and a laser pointer. Also known is another technology for detecting gestures, which are motions made by a user to operate a projection device, and making various operations of the projection device according to the gestures detected.

Japanese Patent Application Laid-open No. 2010-277176 discloses that operating authority for a projection device (image displaying device) is given to a user who made a predetermined motion that is a motion to acquire operating authority to operate a target device of operation performed by the user, and various operations are realized according to gestures that are the motions made by the user to operate the target device of operation when the viewing direction of the user having the operating authority is within a given range.

The conventional technology, however, may make various gesture operations cumbersome and complicated. In the conventional technology, when the user makes various operations of the projection device, the user is required to make the motion to acquire the operating authority, thereby making the user conscious of the motion to acquire the operating authority. As a result, in the conventional technology, the user is made conscious of the motion to acquire the operating authority, and thus the gesture operation that needs to be performed originally may become cumbersome and complicated.

In view of the above, there is a need to provide an information processing apparatus, a computer program product, and a projection system that allow the operability of gesture operation to be improved.

### SUMMARY OF THE INVENTION

It is an object of the present invention to at least partially solve the problems in the conventional technology.

An information processing apparatus includes: a role storage unit that stores therein motion information concerning a motion of a user and a role of the user in a manner associated with each other; a detecting unit that detects a motion of a user; a determining unit that determines a role corresponding to motion information concerning a motion of a user detected by the detecting unit, based on the role storage unit; and an operation authorization unit that gives a user operating authority for an execution target device to be instructed to perform an operation by a predetermined motion of the user, the operating authority corresponding to a role of the user determined by the determining unit.

A computer program product includes a non-transitory computer-usable medium having computer-readable program codes embodied in the medium. The program codes when executed causing a computer to execute: detecting a motion of a user; determining a role corresponding to motion information concerning the detected motion of the user, based on a role storage unit that stores therein motion information concerning a motion of a user and a role of the user in a manner associated with each other; and giving the user operating authority for an execution target device to be instructed to perform operation by a predetermined motion of a user, the operating authority corresponding to the determined role.

A projection system includes: an information processing apparatus; and a projection device to be instructed to perform operation by a predetermined motion of a user. The information processing apparatus includes: a role storage unit that stores therein motion information concerning a motion of a user and a role of the user in a manner associated with each other, a detecting unit that detects a motion of a user, a determining unit that determines a role corresponding to motion information concerning a motion of a user detected by the detecting unit, based on the role storage unit, an operation authorization unit that gives a user operating authority for the projection device, the operating authority corresponding to a role determined by the determining unit, and an operation controlling unit that performs control of the projection device corresponding to an operation according to the predetermined motion of a user according to operating authority that corresponds to a role of the user determined by the determining unit and is given to the user by the operation authorization unit, when a motion of a user detected by the detecting unit is the predetermined motion. The projection device includes: a projection processing unit that performs a given projection process under control of the operation controlling unit of the information processing apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a configuration of a projection system according to a first embodiment;

FIG. 2 is a functional block diagram illustrating an example of a configuration of an information processing apparatus in the first embodiment;

FIG. 3 is a table illustrating an example of information stored in a role storage unit;

FIG. 4 is a diagram for explaining transfer of operating authority;

FIG. 5 is a flowchart illustrating an example of a flow of an overall process in the first embodiment;

FIG. 6 is a flowchart illustrating an example of a flow of a specific process in the first embodiment;

FIG. 7 is a flowchart illustrating an example of a flow of a specific process in the first embodiment;

FIG. 8 is a flowchart illustrating an example of a flow of a specific process in the first embodiment; and

FIG. 9 is a block diagram illustrating implementation of an operation authorization program using a computer.

### DETAILED DESCRIPTION OF THE PREFERRED EMBODIMENTS

With reference to the accompanying drawings, exemplary embodiments of an information processing apparatus, an operation authorization program, and a projection system according to the present invention will be described hereinafter. The invention, however, is not intended to be restricted by the following embodiments.

### First Embodiment

### System Configuration

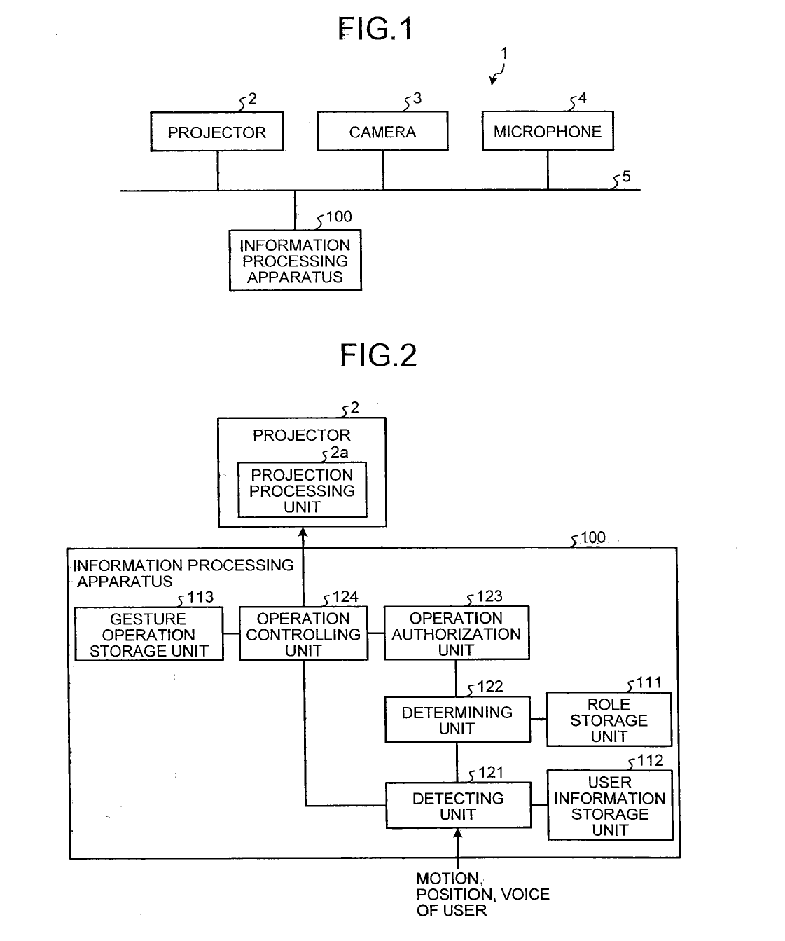

With reference to FIG. 1, the configuration of a projection system according to a first embodiment will be described. FIG. 1 is a block diagram illustrating an example of the configuration of the projection system in the first embodiment.

In a projection system 1, as illustrated in FIG. 1, a projector 2, a camera 3, a microphone 4, and an information processing apparatus 100 are connected to a network 5 such as the Internet and a local area network (LAN). The projector 2 out of the foregoing is a projection device that projects a given image on a plane of projection such as a screen under the control of the information processing apparatus 100. Furthermore, the projector 2 is a device that is an execution target of operation for a predetermined motion of a user who is a participant of a meeting or the like. The predetermined motion of the user is, for example, an action to move hands and fingers and is sometimes referred to as a gesture (gesture operation). The device that is the execution target of gesture operation of the user is not limited to the projector 2, and may be a given device such as a personal computer (PC). In the following description, the projector 2 is illustrated and described as the device of execution target of gesture operation.

The camera 3 is a camera that captures an image of surroundings of the information processing apparatus 100. The camera 3 can be either a camera that captures visible light or a camera that captures infrared light. When the camera 3 is the camera that captures visible light, it is preferable that a plurality of cameras be arranged at appropriate intervals to accurately grasp the position of a user. Meanwhile, when the camera 3 is the camera that captures infrared light, the projection system 1 illustrated in FIG. 1 further includes a light source to emit infrared light. The camera 3 transmits a captured video to the information processing apparatus 100 via the network 5.

The microphone 4 collects voices (for example, utterance of a user). The microphone 4 further transmits the collected voices to the information processing apparatus 100 via the network 5. There may be a situation in which the microphone 4 is not used in the first embodiment, the details of which will be described later.

The information processing apparatus 100 is a device such as a PC that gives a user operating authority for the projector 2 according to a natural motion of the user. The information processing apparatus 100 further includes a storage unit that stores therein motion information concerning motion of users, positional information concerning positions of the users, and voice information concerning voices of the users in a manner associated with roles of the users in a meeting. The storage unit is used to determine roles of users that are participants of the meeting. The information processing apparatus 100 receives the video transmitted by the camera 3, and receives the voices (including utterance of a user) transmitted by the microphone 4 as necessary.

The information processing apparatus 100 then detects the motion and position of a user from the video received from the camera 3, and detects that the user is speaking from the voices received from the microphone 4. The information processing apparatus 100 further determines, based on the information stored in the storage unit, the role of the user corresponding to the motion information concerning the detected motion of the user, the positional information concerning the detected position of the user, or the voice information indicating that the user is speaking or the like. The information processing apparatus 100 subsequently gives the user operating authority for the projector 2 that is the execution target of operation for the gesture made by the user, the operating authority corresponding to the role determined. Consequently, the user who has the operating authority given can operate the projector 2 by making a specific gesture. More specifically, the information processing apparatus 100 gives the operating authority without making the user conscious of the motion to acquire the operating authority, whereby the operability of gesture operation can be improved.

Configuration of Information Processing Apparatus

With reference to FIG. 2, the configuration of the information processing apparatus 100 in the first embodiment will be described. FIG. 2 is a functional block diagram illustrating an example of the configuration of the information processing apparatus 100 in the first embodiment.

As illustrated in FIG. 2, the information processing apparatus 100 includes a role storage unit 111, a user information storage unit 112, a gesture operation storage unit 113, a detecting unit 121, a determining unit 122, an operation authorization unit 123, and an operation controlling unit 124. The projector 2 includes a projection processing unit 2a. The projection processing unit 2a performs, under the control of the information processing apparatus 100, a given projection process such as projecting an image on a screen.

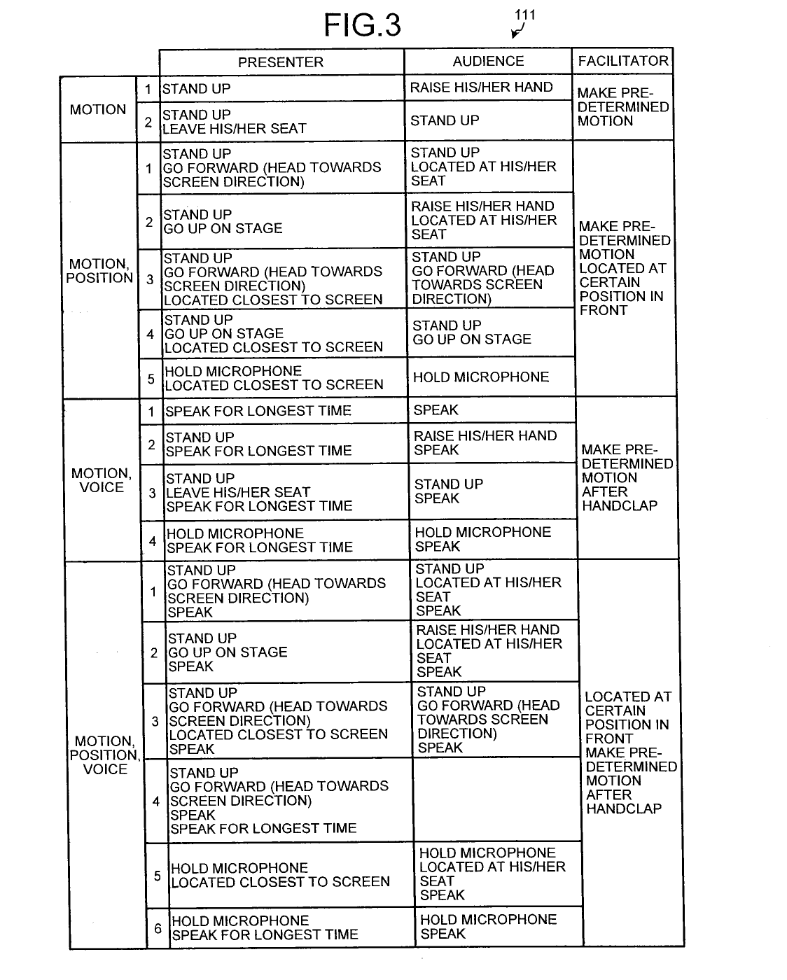

The role storage unit 111 stores therein the motion information of users, the positional information of the users, and the voice information of the users in a manner associated with the roles of the users in a meeting. FIG. 3 is a table illustrating an example of information stored in the role storage unit 111. As illustrated in FIG. 3, the role storage unit 111 stores therein the motion information, the positional information, and the voice information of each of the users in a meeting or the like, in which the projector 2 that is the execution target of gesture operation is used, in a manner associated with roles of the respective users in the meeting or the like. The motion information, the positional information, and the voice information are categorized as Motion; Motion and Position; Motion and Voice; and Motion, Position, and Voice. The roles are categorized as Presenter, Audience, and Facilitator. Which category to use out of the motion information, the positional information, and the voice information may be set in advance based on the size of a meeting room and the number of participants. Alternatively, determination mat be made basically based on the motion only, and the conditions of position and voice may be added when similar motions made by a plurality of users are detected. As a consequence, the information processing apparatus 100 determines a role based on at least the motion of a user detected from the video received from the camera 3, and determines the role as necessary based on the position of the user detected from the video received from the camera 3 and the speaking or the like of the user detected from the voices received from the microphone 4.

As an example, in the case of Motion in which the motion information is used, the role storage unit 111 stores therein Stand Up in a manner associated with Presenter. The role storage unit 111 further stores therein Raise His/Her Hand in the Motion of the motion information in a manner associated with Audience. The role storage unit 111 further stores therein Make Predetermined Motion in the Motion of the motion information in a manner associated with Facilitator. The predetermined motion here is not a gesture but a motion naturally made as a facilitator. In this example in the row of Motion, the operating authority as the presenter is given to the user who stood up, the operating authority as the audience is given to the user who raised his/her hand, and the operating authority as the facilitator is given to the user who made the predetermined motion (a natural motion as a facilitator).

As another example, in the case of Motion, Position in which the motion information and the positional information are used, the role storage unit 111 stores therein Stand Up and Go Forward (Head Towards Screen Direction) in a manner associated with the Presenter. The role storage unit 111 further stores therein Stand Up and Located at His/Her Seat in the Motion and Position of the motion information and the positional information in a manner associated with the Audience. The role storage unit 111 further stores therein Make Predetermined Motion and Located at Certain Position in Front in the Motion and Position of the motion information and the positional information in a manner associated with the Facilitator. In this example in the row of Motion and Position, the user who stood up and went forward is given the operating authority as the presenter, the user who stood up and located at his/her seat is given the operating authority as the audience, and the user who made the predetermined motion (a natural motion as a facilitator) and located at the certain position in front is given the operating authority as the facilitator.

As another example, in the case of Motion, Voice in which the motion information and the voice information are used, the role storage unit 111 stores therein Speak for Longest Time in a manner associated with the Presenter. The role storage unit 111 further stores therein Speak in the Motion and Voice of the motion information and the voice information in a manner associated with the Audience. The role storage unit 111 further stores therein Make Predetermined Motion after Handclap in the Motion and Voice of the motion information and the voice information in a manner associated with the Facilitator. In this example in the row of Motion and Voice, the operating authority as the presenter is given to the user who spoke for the longest time, the operating authority as the audience is given to the user who spoke up, and the operating authority as the facilitator is given to the user who made the predetermined motion (a natural motion as a facilitator) after a handclap.

As another example, in the row of Motion, Position, and Voice of the motion information, the positional information, and the voice information, the role storage unit 111 stores therein Stand Up, Go Forward (Head Towards Screen Direction), and Speak in a manner associated with the Presenter. The role storage unit 111 further stores therein Stand Up, Located at His/Her Seat, and Speak in the Motion, Position, and Voice of the motion information, the positional information, and the voice information in a manner associated with the Audience. The role storage unit 111 further stores therein Located at Certain Position and Make Predetermined Motion after Handclap in Motion, Position, and Voice of the motion information, the positional information, and the voice information in a manner associated with the Facilitator. In this example in the row of Motion, Position, and Voice, the operating authority as the presenter is given to the user who stood up, went forward, and spoke up, the operating authority as the audience is given to the user who stood up and spoke up at his seat, and the operating authority as the facilitator is given to the user who is located at a certain position in front and made the predetermined motion (a natural motion as a facilitator) after a handclap.

The detecting unit 121 uses a video received from the camera 3 to detect the motion and position of a user. The motion of the user is detected from a difference in features of the user for each given number of frames. The position of the user is detected from the position of the user in the video. As for the detection of the foregoing, any techniques can be used. The detecting unit 121 further detects that the user spoke up from the voices received from the microphone 4. The detecting unit 121 that detected the motion, the position, or the speaking of the user stores the various types of information detected in the user information storage unit 112. The user information storage unit 112 stores therein a user located at which position made what motion and spoke up or not. The various types of information stored in the user information storage unit 112 are delivered to the operation authorization unit 123 and the operation controlling unit 124 as necessary.

The determining unit 122 determines a role corresponding to the motion, the position, and the voices of the user. More specifically, the determining unit 122 refers to the role storage unit 111 to determine the role corresponding to the motion, the position, or the speaking of the user detected by the detecting unit 121.

The operation authorization unit 123 gives a user different operating authority for the projector 2 for each of the roles determined. More specifically, the operation authorization unit 123 gives the user the operating authority, which is the authority corresponding to the role determined by the determining unit 122, for the projector 2 that is an execution target of gesture operation of the user. Giving the operating authority to the user by the operation authorization unit 123 is carried out in a known method. A variety of giving methods are available including, as one example, a method in which, in a user database for registering users, the user is registered in a manner associated with the operating authority to be given. In the present embodiment, the operating authority only needs to be registered in a manner associated with the user information stored in the user information storage unit 112. The method of giving the operating authority, however, is not restricted to this. Examples of process to determine the roles according to the motion, the position, or the speaking of the users detected will be described later.

The gesture operation storage unit 113 stores therein operation content of the projector 2 corresponding to gestures. More specifically, the gesture operation storage unit 113 stores therein various types of operation content concerning the projection by the projector 2 such as change of page, magnification and reduction of display, and adjustment of color and brightness in a manner associated with specific gestures that allow for the operation of the projector 2 for the operating authority of respective roles.

The operation controlling unit 124 controls the projector 2 according to the gesture operation of the user. More specifically, when the motion of the user detected by the detecting unit 121 is a gesture operation, the operation controlling unit 124 acquires the operation content from the gesture operation storage unit 113 based on the operating authority given by the operation authorization unit 123. The operation controlling unit 124 then controls the projector 2 according to the operation content acquired. As an example, when the operation content of Change to Next Page is acquired from the gesture operation storage unit 113 based on the operating authority of the user and the gesture performed by the user, the operation controlling unit 124 controls the projector 2 to change the page of the image currently projected to that of the next page.

Transfer of Operating Authority

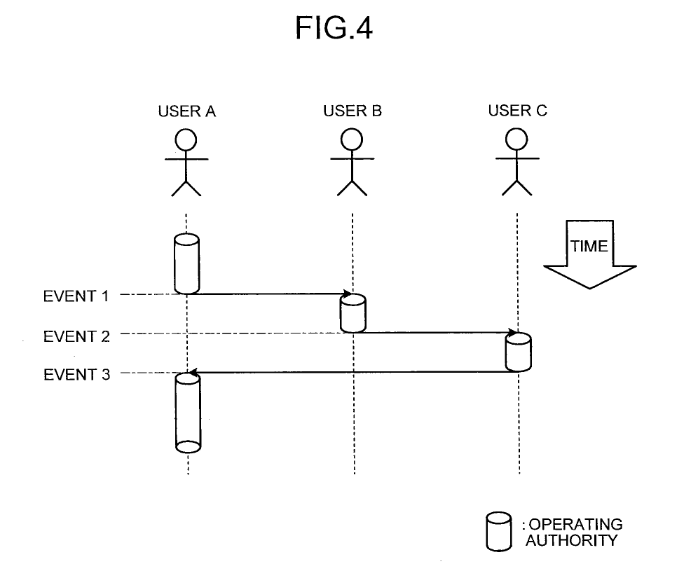

With reference to FIG. 4, the transfer of operating authority will be described. FIG. 4 is a diagram for explaining the transfer of operating authority.

As illustrated in FIG. 4, in a condition in which a User A has operating authority, when a User B stands up and an Event 1 that switches presenters (roles) occurs, the information processing apparatus 100 determines the role Presenter for the User B and gives the operating authority to the User B as a presenter. Consequently, the operating authority is transferred from the User A to the User B. However, the operating authority of the User B is the operating authority as the presenter, and thus, even when the User B makes a gesture as an audience or a facilitator, the gesture is not accepted at this point because the User B has no operating authority as the foregoing.

Furthermore, in a condition in which the User B has the operating authority, when a User C stands up and an Event 2 that switches presenters (roles) occurs, the information processing apparatus 100 determines the role Presenter for the User C and gives the operating authority to the User C as the presenter. Consequently, the operating authority is transferred from the User B to the User C. However, the operating authority of the User C is the operating authority as the presenter, and thus, even when the User C makes a gesture as an audience or a facilitator, the gesture is not accepted at this point because the User C has no operating authority as the foregoing.

Moreover, in a condition in which the User C has the operating authority, when the User A raises his/her hand and an Event 3 that turns the User A as an audience (role) occurs, the information processing apparatus 100 determines the role Audience for the User A and gives the operating authority to the User A as the audience. Consequently, the operating authority is transferred from the User C to the User A. However, the operating authority of the User A is the operating authority as the audience, and thus, even when the User A makes a gesture as the presenter or the facilitator, the gesture is not accepted at this point because the User A has no operating authority as the foregoing.

In the manner described above, the information processing apparatus 100 transfers the operating authority to be given to respective users when an event that is a natural motion of the user occurs.

Overall Processing Flow

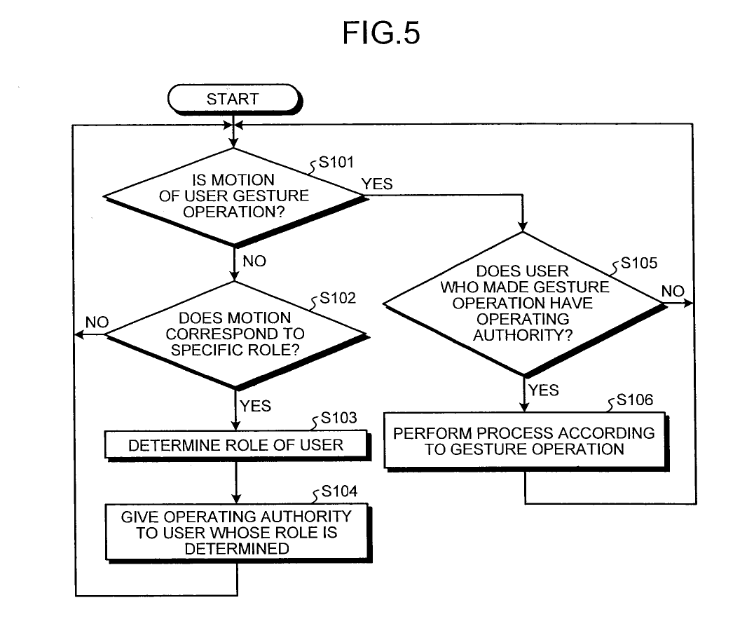

With reference to FIG. 5, the flow of an overall process in the first embodiment will be described. FIG. 5 is a flowchart illustrating an example of the flow of the overall process in the first embodiment.

As illustrated in FIG. 5, when a motion of a user detected by the detecting unit 121 is not a gesture operation (No at Step S101), the determining unit 122 determines whether the motion corresponds to a specific role of a presenter, an audience, or a facilitator (Step S102). At this time, when the motion is determined to correspond to the specific role (Yes at Step S102), the determining unit 122 determines a role of the user (Step S103). The operation authorization unit 123 then gives operating authority to the user whose role is determined by the determining unit 122 (Step S104). In contrast, when the motion is determined not to correspond to a specific role by the detecting unit 121 (No at Step S102), the process at Step S101 is performed again. Whether a motion corresponds to a specific role is determined by referring to the role storage unit 111.

When the motion of the user detected by the detecting unit 121 is the gesture operation (Yes at Step S101), the operation controlling unit 124 determines whether the user who made the gesture operation has the operating authority (Step S105). Whether the user has the operating authority is determined from information concerning the operating authority given to the user by the operation authorization unit 123 (for example, the content of operating authority associated with the user registered in the user database). At this time, when the user who performed the gesture operation is determined to have the operating authority (Yes at Step S105), the operation controlling unit 124 acquires the operation content corresponding to the gesture operation from the gesture operation storage unit 113, and controls the projector 2 according to the operation content acquired (Step S106). However, even while the user has the operating authority of a specific role, when the gesture operation the user performed does not correspond to the operating authority of the specific role, the gesture operation is not accepted. In contract, when the user who performed the gesture operation is determined not to have the operating authority by the operation controlling unit 124 (No at Step S105), the process at Step S101 is performed again.

### Processing Example 1

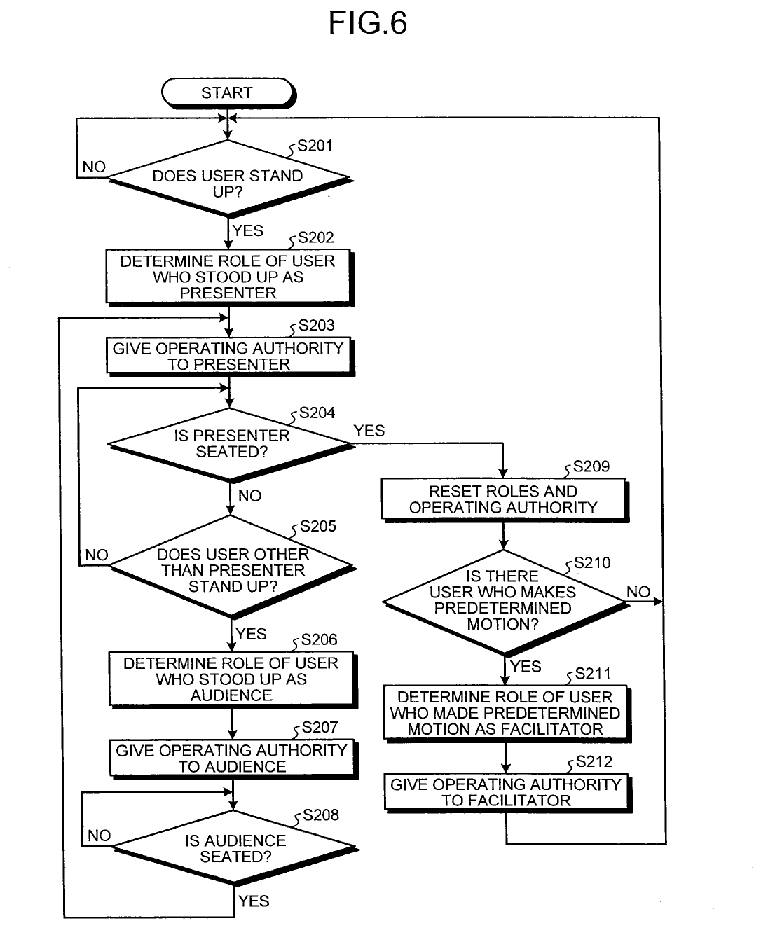

With reference to FIG. 6, the flow of a specific process in the first embodiment will be described. FIG. 6 is a flowchart illustrating an example of the flow of the specific process in the first embodiment. In FIG. 6, a case in which the Motion out of the motion information is mainly used will be illustrated and described.

As illustrated in FIG. 6, when the detecting unit 121 detects that a user stands up from the video received from the camera 3 (Yes at Step S201), the determining unit 122 determines the role of the user who stood up as a presenter (Step S202). In the following description for FIG. 6, the user determined as the presenter may be referred to as a User X. In contract, when the detecting unit 121 does not detect that a user stands up (No at Step S201), the detecting unit 121 performs the process at Step S201 again. The operation authorization unit 123 then gives operating authority to the User X whose role is determined as the presenter by the determining unit 122 (Step S203). While the operating authority is given to the User X who is the presenter, and when the User X performs a gesture to operate the projector 2, the operation controlling unit 124 acquires the operation content corresponding to the gesture from the gesture operation storage unit 113 and controls the projector 2 according to the operation content acquired.

When the detecting unit 121 further determines that the User X of the presenter is not seated from the video received from the camera 3 (No at Step S204), the detecting unit 121 determines whether a user other than the User X of the presenter stands up (Step S205). At this time, when the detecting unit 121 detects that the user other than the User X of the presenter stands up (Yes at Step S205), the determining unit 122 determines the role of the user who stood up as an audience (Step S206). In the following description for FIG. 6, the user determined as the audience may be referred to as a User Y.

In contrast, when the detecting unit 121 does not detect that a user other than the User X of the presenter stands up (No at Step S205), the detecting unit 121 performs the process at Step S204 again. The operation authorization unit 123 then gives the operating authority to the User Y whose role is determined by the determining unit 122 as the audience (Step S207). More specifically, the operating authority is transferred at this point from the User X of the presenter to the User Y of the audience. While the operating authority is given to the User Y of the audience, and when the User Y performs a gesture to operate the projector 2, the operation controlling unit 124 acquires the operation content corresponding to the gesture from the gesture operation storage unit 113 and controls the projector 2 according to the operation content acquired.

When the detecting unit 121 determines that the User Y of the audience is seated from the video received from the camera 3 (Yes at Step S208), the operation authorization unit 123 gives the operating authority to the User X of the presenter (Step S203). More specifically, the operating authority is transferred at this point from the User Y of the audience to the User X of the presenter. While the operating authority is given to the User X of the presenter, and when the User X performs a gesture to operate the projector 2, the operation controlling unit 124 acquires the operation content corresponding to the gesture from the gesture operation storage unit 113 and controls the projector 2 by the operation content acquired. In contract, when the detecting unit 121 detects that the User Y of the audience is not seated from the video received from the camera 3 (No at Step S208), the detecting unit 121 performs the process at Step S208 again.

When the detecting unit 121 determines that the User X of the presenter took his/her seat (or is seated) from the video received from the camera 3 (Yes at Step S204), the operation authorization unit 123 resets the roles for the respective users, such as the User X and the User Y, and the operating authority, more specifically, sets a condition in which no roles and no operating authority are given to any users (Step S209).

When the detecting unit 121 detects the presence of a user who makes a predetermined motion (natural motion as a facilitator) from the video received from the camera 3 (Yes at Step S210), the determining unit 122 determines the role of the user who made the predetermined motion (natural motion as a facilitator) as a facilitator (Step S211). In contract, when the detecting unit 121 determines that there is no user who makes the predetermined motion (natural motion as a facilitator) (No at Step S210), the detecting unit 121 performs the process at Step S201 again. The operation authorization unit 123 then gives the operating authority to the user whose role is determined as the facilitator (Step S212). While the operating authority is given to the user of the facilitator, and when the user performs a gesture to operate the projector 2, the operation controlling unit 124 acquires the operation content corresponding to the gesture from the gesture operation storage unit 113 and controls the projector 2 according to the operation content acquired.

### Processing Example 2

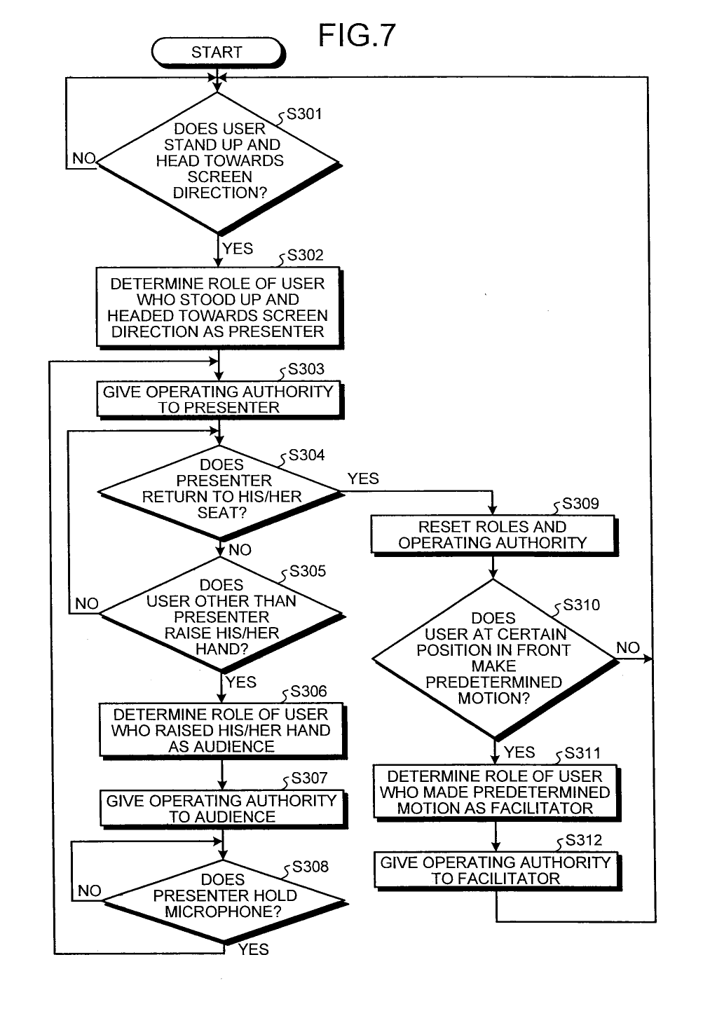

With reference to FIG. 7, the flow of a specific process in the first embodiment will be described. FIG. 7 is a flowchart illustrating an example of the flow of the specific process in the first embodiment. In FIG. 7, a case in which the Motion and Position out of the motion information are mainly used will be illustrated and described.

As illustrated in FIG. 7, when the detecting unit 121 detects that a user stands up and heads towards a screen direction from the video received from the camera 3 (Yes at Step S301), the determining unit 122 determines the role of the user who stood up and headed towards the screen direction as a presenter (Step S302). In the following description for FIG. 7, the user determined as the presenter may be referred to as a User X. In contract, when the detecting unit 121 does not detect that a user stands up and heads towards the screen direction (No at Step S301), the detecting unit 121 performs the process at Step S301 again. The operation authorization unit 123 then gives operating authority to the User X who is determined as the presenter by the determining unit 122 (Step S303). While the operating authority is given to the User X of the presenter, and when the User X performs a gesture to operate the projector 2, the operation controlling unit 124 acquires the operation content corresponding to the gesture from the gesture operation storage unit 113 and controls the projector 2 according to the operation content acquired.

When the detecting unit 121 further detects that the User X of the presenter does not return to his/her seat from the video received from the camera 3 (No at Step S304), the detecting unit 121 determines whether a user other than the User X of the presenter raises his/her hand (Step S305). At this time, when the detecting unit 121 detects that a user other than the User X of the presenter raises his/her hand (Yes at Step S306), the determining unit 122 determines the role of the user who raised his/her hand as an audience (Step S306). In the following description for FIG. 7, the user determined as the audience may be referred to as a User Y.

In contract, when the detecting unit 121 does not detect that a user other than the User X of the presenter raised his/her hand (No at Step S305), the detecting unit 121 performs the process at Step S304 again. The operation authorization unit 123 then gives the operating authority to the User Y whose role is determined as the audience by the determining unit 122 (Step S307). More specifically, the operating authority is transferred at this point from the User X of the presenter to the User Y of the audience. While the operating authority is given to the User Y of the audience, and when the User Y performs a gesture to operate the projector 2, the operation controlling unit 124 acquires the operation content corresponding to the gesture from the gesture operation storage unit 113 and controls the projector 2 according to the operation content acquired.

When the detecting unit 121 further determines that the User X of the presenter holds a microphone from the video received from the camera 3 (Yes at Step S308), the operation authorization unit 123 gives the operating authority to the User X of the presenter (Step S303). More specifically, the operating authority is transferred at this point from the User Y of the audience to the User X of the presenter. While the operating authority is given to the User X of the presenter, and when the User X performs a gesture to operate the projector 2, the operation controlling unit 124 acquires the operation content corresponding to the gesture from the gesture operation storage unit 113 and controls the projector 2 according to the operation content acquired. In contract, when the detecting unit 121 determines that the User X of the presenter does not hold a microphone from the video received from the camera 3 (No at Step S308), the detecting unit 121 performs the process at Step S308 again.

When the detecting unit 121 further determines that the User X of the presenter returns to his/her seat (or is returning to his/her seat) from the video received from the camera 3 (Yes at Step S304), the operation authorization unit 123 resets the roles for the respective users, such as the User X and the User Y, and the operating authority to set a condition in which no roles and no operating authority are given to any users (Step S309).

When the detecting unit 121 further detects that a user located at a certain position in front makes a predetermined motion (natural motion as a facilitator) from the video received from the camera 3 (Yes at Step S310), the determining unit 122 determines the role of the user as a facilitator (Step S311). In contrast, when the detecting unit 121 determines that the user located at the certain position in front does not make the predetermined motion (natural motion as a facilitator) from the video received from the camera 3 (No at Step S310), the detecting unit 121 performs the process at Step S301 again. The operation authorization unit 123 then gives the operating authority to the user whose role is determined by the determining unit 122 as the facilitator (Step S312). While the operating authority is given to the user of the facilitator, and when the user performs a gesture to operate the projector 2, the operation controlling unit 124 acquires the operation content corresponding to the gesture from the gesture operation storage unit 113 and controls the projector 2 according to the operation content acquired.

### Processing Example 3

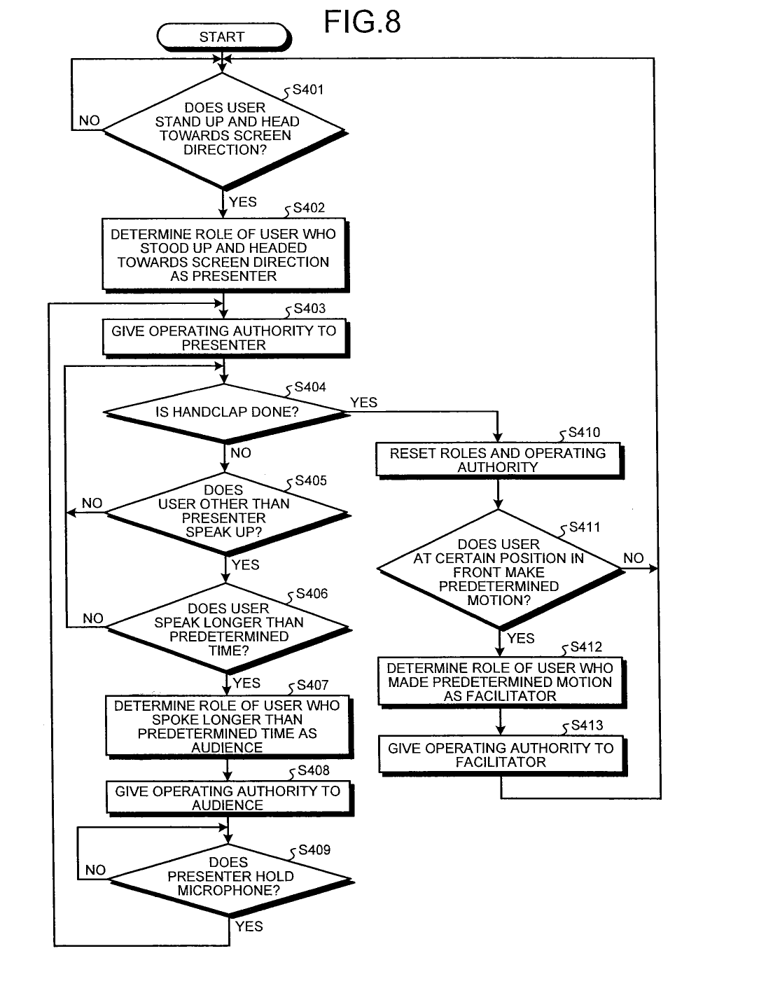

With reference to FIG. 8, the flow of a specific process in the first embodiment will be described. FIG. 8 is a flowchart illustrating an example of the flow of the specific process in the first embodiment. In FIG. 8, a case in which the Motion, Position, and Voice out of the motion information are mainly used will be illustrated and described.

As illustrated in FIG. 8, when the detecting unit 121 detects that a user stands up and heads towards a screen direction from the video received from the camera 3 (Yes at Step S401), the determining unit 122 determines the role of the user who stood up and headed towards the screen direction as a presenter (Step S402). In the following description for FIG. 8, the user determined as the presenter may be referred to as a User X. In contract, when the detecting unit 121 does not detect that a user stands up and heads towards the screen direction (No at Step S401), the detecting unit 121 performs the process at Step S401 again. The operation authorization unit 123 then gives operating authority to the User X whose role is determined as the presenter by the determining unit 122 (Step S403). While the operating authority is given to the User X of the presenter, and when the User X performs a gesture to operate the projector 2, the operation controlling unit 124 acquires the operation content corresponding to the gesture from the gesture operation storage unit 113 and controls the projector 2 according to the operation content acquired.

Furthermore, when the detecting unit 121 does not detect that a handclap is done in a meeting room from the video received from the camera 3 and the voices received from the microphone 4 (No at Step S404), the detecting unit 121 determines whether a user other than the User X of the presenter speaks (Step S405). At this time, when the detecting unit 121 determines that the user other than the User X of the presenter speaks (Yes at Step S405), the detecting unit 121 determines whether the user speaks for longer than a predetermined time (Step S406). When the detecting unit 121 determines that the user other than the User X of the presenter speaks for longer than the predetermined time (Yes at Step S406), the determining unit 122 determines the role of the user who spoke for longer than the predetermined time as an audience (Step S407). In the following description for FIG. 8, the user determined as the audience may be referred to as a User Y.

In contract, when the detecting unit 121 determines that a user other than the User X of the presenter does not speak (No at Step S405) or a user other than the User X of the presenter does not speak for longer than the predetermined time (No at Step S406), the detecting unit 121 performs the process at Step S404 again. The operation authorization unit 123 then gives the operating authority to the User Y whose role is determined as the audience by the determining unit 122 (Step S408). More specifically, the operating authority is transferred at this point from the User X of the presenter to the User Y of the audience. While the operating authority is given to the User Y of the audience, and when the User Y performs a gesture to operate the projector 2, the operation controlling unit 124 acquires the operation content corresponding to the gesture from the gesture operation storage unit 113 and controls the projector 2 according to the operation content acquired.

When the detecting unit 121 further determines that the User X of the presenter holds a microphone from the video received from the camera 3 (Yes at Step S409), the operation authorization unit 123 gives the operating authority to the User X of the presenter (Step S403). More specifically, the operating authority is transferred from the User Y of the audience to the User X of the presenter at this point. While the operating authority is given to the User X of the presenter, and when the User X performs a gesture to operate the projector 2, the operation controlling unit 124 acquires the operation content corresponding to the gesture from the gesture operation storage unit 113 and controls the projector 2 according to the operation content acquired. In contract, when the detecting unit 121 determines that the User X of the presenter does not hold a microphone from the video received from the camera 3 (No at Step S409), the detecting unit 121 performs the process at Step S409 again.

When the detecting unit 121 further detects that the handclap is done inside the meeting room from the video received from the camera 3 and the voices received from the microphone 4 (Yes at Step S404), the operation authorization unit 123 resets the roles for the respective users, such as the User X and the User Y, and the operating authority to set a condition in which no roles and no operating authority are given to any users (Step S410).

When the detecting unit 121 further detects that a user located at a certain position in front makes a predetermined motion (natural motion as a facilitator) from the video received from the camera 3 (Yes at Step S411), the determining unit 122 determines the role of the user as a facilitator (Step S412). In contrast, when the detecting unit 121 determines that the user located at the certain position in front does not make the predetermined motion (natural motion as a facilitator) (No at Step S411), the detecting unit 121 performs the process at Step S401 again. The operation authorization unit 123 then gives operating authority to the user whose role is determined by the determining unit 122 as the facilitator (Step S413). While the operating authority is given to the user of the facilitator, and when the user performs a gesture to operate the projector 2, the operation controlling unit 124 acquires the operation content corresponding to the gesture from the gesture operation storage unit 113 and controls the projector 2 according to the operation content acquired.

Effects of First Embodiment

As in the foregoing, the information processing apparatus 100 includes the role storage unit that stores therein the motion information of users in a meeting or the like in a manner associated with the roles of the users in the meeting or the like, detects the motion, the position, or the voice of a user, and determines the role corresponding to the detected motion, the detected position, or the detected voice of the user, based on the role storage unit. The information processing apparatus 100 then gives the user the operating authority for the projector 2 that is the execution target of gesture operation, the operating authority corresponding to the role of the user determined. As a consequence, the information processing apparatus 100 gives the operating authority according to a natural motion of the user or the like, whereby the operability of gesture operation can be improved as compared with the conventional technology that makes the user conscious of the motion to acquire the operating authority.

### Second Embodiment

While the embodiment of the information processing apparatus 100 according to the present invention is described above, the invention may be implemented in various different embodiments other than the above-described embodiment. Thus, different embodiments in (1) configurations and (2) programs will be described.

(1) Configuration

The processing procedures, control procedures, specific names, and information including various types of data, parameters, and the like illustrated in the writing above and in the drawings can be optionally changed, except when specified otherwise. For example, the information that the role storage unit 111 stores therein is not limited to those illustrated in the drawings and can be changed accordingly.

The constituent elements of the information processing apparatus 100 illustrated are functionally conceptual and are not necessarily configured physically as illustrated in the drawings. In other words, the specific embodiments of distribution or integration of devices are not restricted to those illustrated, and the whole or a part thereof can be configured by being functionally or physically distributed or integrated in any unit according to various types of loads and usage. For example, the operation controlling unit 124 may be distributed to a gesture recognizing unit that recognizes the gesture of the user, and a controlling unit that controls the projector 2 according to the operation content according to the recognized gesture.

(2) Program

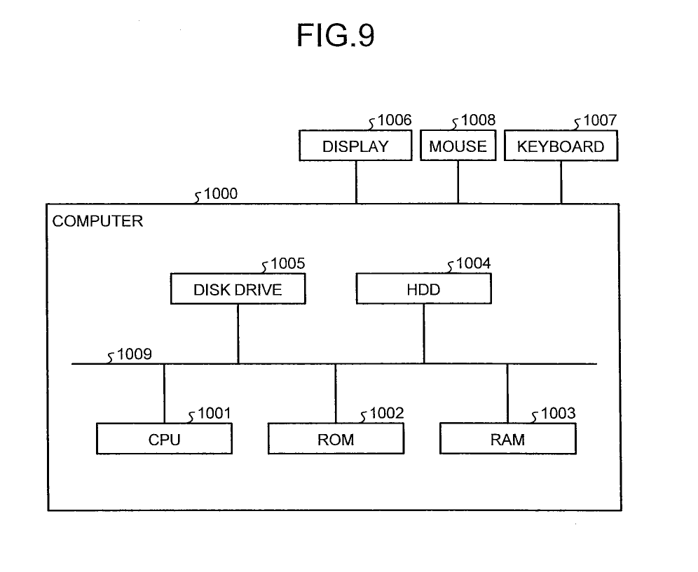

FIG. 9 is a block diagram illustrating the implementation of an operation authorization program using a computer. For example, as illustrated in FIG. 9, a computer 1000 as the information processing apparatus 100 includes a control device such as a central processing unit (CPU) 1001, a storage device such as a read only memory (ROM) 1002 and a random access memory (RAM) 1003, a hard disk drive (HDD) 1004, an external storage device such as a disk drive 1005, a display device such as a display 1006, and input devices such as a keyboard 1007 and a mouse 1008, and is hardware configured using a normal computer.

The operation authorization program executed by the information processing apparatus 100 is provided, as one aspect, in a file of an installable format or an executable format recorded on a computer readable recording medium such as a compact disc read-only memory (CD-ROM), a flexible disk (FD), a compact disc-recordable (CD-R), a digital versatile disk (DVD). Furthermore, the operation authorization program executed by the information processing apparatus 100 may be configured to be stored on a computer connected to a network such as the Internet and to be provided by downloading it via the network. The operation authorization program executed by the information processing apparatus 100 may be configured to be provided or distributed via a network such as the Internet. The operation authorization program may further be configured to be provided being embedded in a ROM or the like.

The operation authorization program executed by the information processing apparatus 100 is modularly configured to include the above-described functional units (the detecting unit 121, the determining unit 122, and the operation authorization unit 123). As for the actual hardware, a CPU (processor) reads out the operation authorization program from a storage medium and executes it to load each of the above-described functional units on a main storage device, whereby the detecting unit 121, the determining unit 122, and the operation authorization unit 123 are generated on the main storage device.

The embodiment has an effect to allow the operability of gesture operation to be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a role storage unit that stores therein motion information concerning a motion of a user and a role of the user in a manner associated with each other;
a detecting unit that detects a motion of a user;
a determining unit that determines a role corresponding to motion information concerning a motion of a user detected by the detecting unit, based on the role storage unit; and
an operation authorization unit that gives a user operating authority for an execution target device to be instructed to perform an operation by a predetermined motion of the user, the operating authority corresponding to a role of the user determined by the determining unit.

2. The information processing apparatus according to claim 1, further comprising an operation controlling unit that performs control of the execution target device corresponding to an operation according to the predetermined motion of a user according to operating authority that corresponds to a role of the user determined by the determining unit and is given to the user by the operation authorization unit, when a motion of the user detected by the detecting unit is the predetermined motion.

3. The information processing apparatus according to claim 1, wherein
the role storage unit further stores therein positional information concerning a position of a user in a manner associated with a role,
the detecting unit further detects a position of a user, and
the determining unit determines a role corresponding to motion information concerning a motion of a user detected by the detecting unit and positional information concerning a position of the user detected by the detecting unit, based on the role storage unit.

4. The information processing apparatus according to claim 1, wherein
the role storage unit further stores therein voice information concerning voice of a user in a manner associated with a role,
the detecting unit further detects voice of a user, and
the determining unit determines a role corresponding to motion information concerning a motion of a user detected by the detecting unit and voice information concerning voice of the user detected by the detecting unit, based on the role storage unit.

5. The information processing apparatus according to claim 1, wherein
the role storage unit further stores therein positional information concerning a position of a user and voice information concerning voice of a user in a manner associated with a role,
the detecting unit further detects a position and voice of a user, and
the determining unit determines a role corresponding to motion information concerning a motion of a user detected by the detecting unit, positional information concerning a position of the user detected by the detecting unit, and voice information concerning voice of the user detected by the detecting unit, based on the role storage unit.

6. A computer program product comprising a non-transitory computer-usable medium having computer-readable program codes embodied in the medium, wherein the program codes when executed causing a computer to execute:
detecting a motion of a user;
determining a role corresponding to motion information concerning the detected motion of the user, based on a role storage unit that stores therein motion information concerning a motion of a user and a role of the user in a manner associated with each other; and
giving the user operating authority for an execution target device to be instructed to perform operation by a predetermined motion of a user, the operating authority corresponding to the determined role.

7. A projection system comprising:
an information processing apparatus; and
a projection device to be instructed to perform operation by a predetermined motion of a user, wherein
the information processing apparatus comprises:
a role storage unit that stores therein motion information concerning a motion of a user and a role of the user in a manner associated with each other,
a detecting unit that detects a motion of a user,
a determining unit that determines a role corresponding to motion information concerning a motion of a user detected by the detecting unit, based on the role storage unit,
an operation authorization unit that gives a user operating authority for the projection device, the operating authority corresponding to a role determined by the determining unit, and
an operation controlling unit that performs control of the projection device corresponding to an operation according to the predetermined motion of a user according to operating authority that corresponds to a role of the user determined by the determining unit and is given to the user by the operation authorization unit, when a motion of a user detected by the detecting unit is the predetermined motion, and
the projection device comprises:
a projection processing unit that performs a given projection process under control of the operation controlling unit of the information processing apparatus.

8. The projection system according to claim 7, wherein
the role storage unit further stores therein positional information concerning a position of a user in a manner associated with a role,
the detecting unit further detects a position of a user, and
the determining unit determines a role corresponding to motion information concerning a motion of a user detected by the detecting unit and positional information concerning a position of the user detected by the detecting unit, based on the role storage unit.

9. The projection system according to claim 7, wherein
the role storage unit further stores therein voice information concerning voice of a user in a manner associated with a role,
the detecting unit further detects voice of a user, and
the determining unit determines a role corresponding to motion information concerning a motion of a user detected by the detecting unit and voice information concerning voice of the user detected by the detecting unit, based on the role storage unit.

10. The projection system according to claim 7, wherein
the role storage unit further stores therein positional information concerning a position of a user and voice information concerning voice of a user in a manner associated with a role,
the detecting unit further detects a position and voice of a user, and
the determining unit determines a role corresponding to motion information concerning a motion of a user detected by the detecting unit, positional information concerning a position of the user detected by the detecting unit, and voice information concerning voice of the user detected by the detecting unit, based on the role storage unit.
